(19) United States
(12) Patent Application Publication
(10) Pub. No.: US 2026/0146963 A1
(43) Pub. Date: May 28, 2026

(54) Measurement Apparatus and Method of Thermal Shrinkage Ratio of a Separator

(71) Applicant: LG Chem, Ltd., Seoul (KR)

(72) Inventors: Jae Young Moon, Daejeon (KR); Sung Hak Bae, Daejeon (KR); Sang Hyuk Jeon, Daejeon (KR)

(73) Assignee: LG Chem, Ltd., Seoul (KR)

(21) Appl. No.: 18/870,156

(22) PCT Filed: Aug. 24, 2023
(86) PCT No.: PCT/KR2023/012534

§ 371 Date: Nov. 27, 2024

(30) Foreign Application Priority Data
Sep. 22, 2022 (KR) 1020220119715

(51) Int. Cl. G01N 25/16; H01M 50/489

(52) U.S. Cl. CPC G01N 25/16; H01M 50/489

(57) ABSTRACT

Disclosed are a separator thermal shrinkage rate evaluation device and evaluation method that can easily evaluate the thermal shrinkage rate of a separator.

### TECHNICAL FIELD

The present disclosure claims the benefit of the filing date of Korean Patent Application No. 10-2022-0119715, filed with the Korean Intellectual Property Office on Sep. 22, 2022, the entire contents of which are included in the present disclosure.

The present disclosure relates to a separator thermal shrinkage rate evaluation device and evaluation method that can easily evaluate the thermal shrinkage rate of a separator that is one of the basic materials of a battery.

### BACKGROUND ART

In general, a separator is one of the basic materials of a battery that stores battery energy. Such a separator is located between a positive electrode and a negative electrode of the battery, physically blocks contact between the two electrodes, and selectively allows only small lithium ions to pass therethrough, making it essential for safe use of electrical energy.

Recently, as fires occur in vehicles and facilities using large-capacity batteries, the safety of the batteries has become more important. Accordingly, the safety standards of the separator are also being strengthened.

A separator thermal shrinkage rate evaluation item, which is one of the items for evaluating the stability of the separator, is a method for evaluating the degree of shrinkage of the separator due to heat.

Specifically, in a method for measuring a thermal shrinkage rate in the related art, a separator sample is shrunk at specific temperature and time, and then a worker directly measures the degree of shrinkage by using a ruler.

However, the thermal shrinkage rate evaluation method in the related art as described above is based on the concept of simply measuring the length of the separator sample, and has the disadvantage of low accuracy and reliability and very low evaluation speed. In particular, when the separator sample is shrunk and then does not maintain a square shape with an interior angle of 90°, measuring a shrinkage rate may be difficult.

### DISCLOSURE

### Technical Problem

Embodiments of the present disclosure intend to provide a separator thermal shrinkage rate evaluation device and evaluation method that can easily evaluate the thermal shrinkage rate of a separator.

### Technical Solution

A separator thermal shrinkage rate evaluation device according to the present disclosure for implementing the object described above may include: a mounting table on which a separator sample to be evaluated is placed; a lighting unit that emits light toward at least one of a top surface or a bottom surface of the separator sample; an imaging unit that takes an image of the separator sample; and an evaluation unit that determines a degree of shrinkage of the separator sample by comparing values of a length in each direction of the separator sample measured through the image taken by the imaging unit with a reference value before thermal shrinkage.

In such a case, at least four reference points constituting a square among a plurality of points representing a border of the separator sample may be set on the separator sample.

The separator sample may be formed into a square shape, and the reference point may be a vertex of the separator sample.

The evaluation unit may include: a first measurement range set so that two points closest to a center of a plane of the separator sample in a Y-axis direction are selected from the four reference points, parallel virtual horizontal lines respectively passing through the selected two points are formed, and a plurality of lengths of the separator sample in an X-axis direction are measured in a range between the virtual horizontal lines; and a second measurement range set so that two points closest to the center of the plane of the separator sample in the X-axis direction are selected from the four reference points, parallel virtual vertical lines respectively passing through the selected two points are formed, and a plurality of lengths of the separator sample in the Y-axis direction are measured in a range between the virtual vertical lines.

The evaluation unit may select, as a measurement value, the shortest length among the plurality of lengths measured in the first measurement range and the second measurement range.

The evaluation unit may ascertain the separator sample by using a difference in brightness or gray scale of the taken image.

The lighting unit may include: a first lighting unit that is provided below the mounting table and emits light toward a bottom surface of the separator sample; and a second lighting unit that is provided above the mounting table and emits light toward a top surface of the separator sample.

The first lighting unit may be integrally inserted inside the mounting table and may emit light toward an entire area of the mounting table.

The imaging unit may be provided above the mounting table.

A separator thermal shrinkage rate evaluation method according to the present disclosure may include: a first step of cutting a separator sample to be evaluated to a reference value of a predetermined size and setting at least four reference points on an upper surface of the cut separator sample; a second step of shrinking the separator sample by applying heat at a predetermined temperature for a predetermined period of time; a third step of placing the shrunk separator sample on an upper surface of a mounting table and taking an image of the separator sample; a fourth step of selecting two points closest to a center of a plane of the separator sample in a Y-axis direction among the four reference points on the basis of the taken image, forming parallel virtual horizontal lines respectively passing through the two selected points, and measuring a length of the separator sample in an X-axis direction in a range between the virtual horizontal lines; a fifth step of selecting two points closest to the center of the plane of the separator sample in the X-axis direction among the four reference points on the basis of the taken image, forming parallel virtual vertical lines respectively passing through the two selected points, and measuring a length of the separator sample in the Y-axis direction in a range between the virtual vertical lines; and a sixth step of calculating a thermal shrinkage rate by comparing the lengths measured in the X-axis direction and the Y-axis direction with a reference value.

In such a case, in the fourth step and the fifth step, the shortest length of the lengths measured in the X-axis direction and the Y-axis direction may be selected as a measurement value.

### Advantageous Effects

A separator thermal shrinkage rate evaluation device and evaluation method configured as described above according to the present disclosure have the advantage of setting first and second measurement ranges in an X-axis direction and a Y-axis direction, respectively, on the basis of four reference points set on a separator sample forming a square, and measuring a thermal shrinkage rate by comparing measured values obtained by measuring the shortest lengths of the separator sample in the measurement ranges with a reference value, thereby obtaining more accurate data.

### BRIEF DESCRIPTION OF DRAWINGS

FIG. 1 is an overall schematic diagram illustrating a separator thermal shrinkage rate evaluation device according to the present disclosure.

FIG. 2 is a schematic perspective view of the separator thermal shrinkage rate evaluation device according to the present disclosure.

FIG. 3 is a plan view illustrating a separator sample before and after thermal shrinkage according to the present disclosure.

FIG. 4 is a view illustrating the principle in which an evaluation unit according to the present disclosure evaluates a shrinkage rate of the separator sample in an X-axis direction.

FIG. 5 is a view illustrating the principle in which the evaluation unit according to the present disclosure evaluates a shrinkage rate of the separator sample in an X-axis direction.

### DESCRIPTION OF REFERENCE NUMERALS

1: separator sample
L1, L2: measurement values
P1˜P4: reference point
R: reference value
d1: first measurement range
d2: second measurement range
h1, h2: virtual horizontal line
v1, v2: virtual vertical line
100: thermal shrinkage rate evaluation device
110: mounting table
120: lighting unit
121: first lighting unit
122: second lighting unit
140: imaging unit
150: evaluation unit

### Best Mode

Hereinafter, the configuration and operation of specific embodiments of the present disclosure are described in detail with reference to the accompanying drawings.

Noted that in assigning reference numerals to elements in the drawings, the same reference numerals denote the same elements throughout the drawings even in cases where the elements are shown in different drawings.

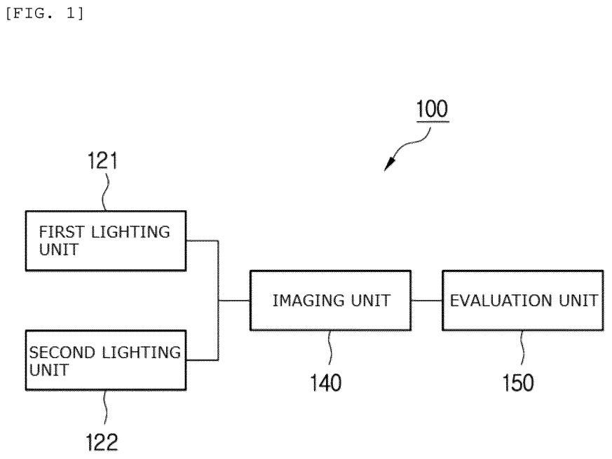

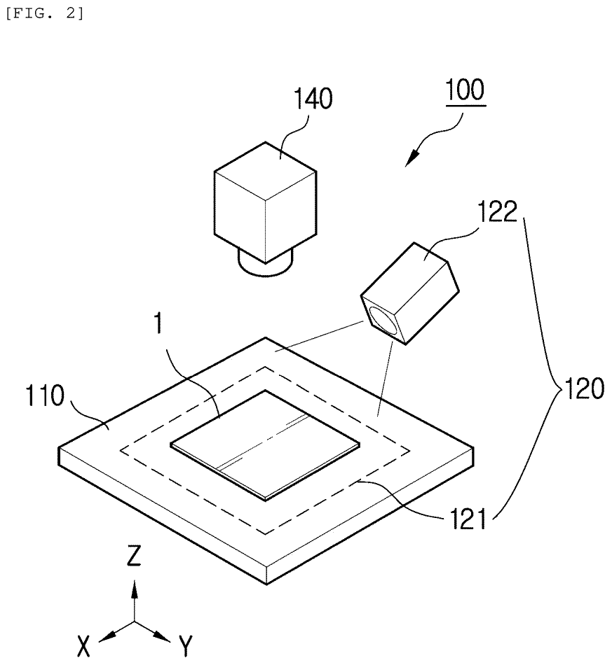

FIG. 1 is an overall schematic diagram illustrating a separator thermal shrinkage rate evaluation device according to the present disclosure, and FIG. 2 is a schematic perspective view of the separator thermal shrinkage rate evaluation device according to the present disclosure.

Referring to FIGS. 1 and 2, a separator thermal shrinkage rate evaluation device 100 according to a preferred embodiment of the present disclosure includes a mounting table 110, a lighting unit 120, an imaging unit 140, and an evaluation unit 150.

A detailed description of the configuration of the present disclosure is as follows.

First, the mounting table 110 may be formed as a plate having a top surface on which a separator sample 1 to be evaluated can be placed. Such a mounting table 110 may be made of a transparent or semi-transparent material so that the boundary of the separator sample 1 can be easily ascertained through the lighting unit 120 to be described below. Of course, the mounting table 110 is not limited thereto and can be variously changed and applied.

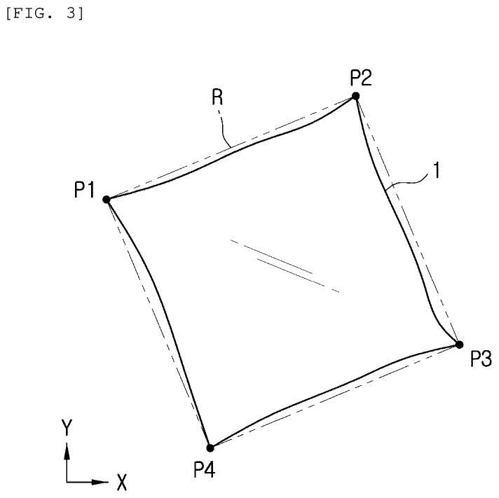

Referring to FIG. 3, the separator sample 1 placed on the mounting table 110 may be formed into, for example, a square shape (5 cm×5 cm) so that the degree of shrinkage may be easily measured, and on an upper surface of the mounting table 110, the separator sample 1 shrunk due to heat may be placed.

That is, a size reference value R before shrinkage of the separator sample 1 may be a standardized square shape, and accordingly, the degree of shrinkage may be evaluated by measuring the length in a specific direction of the separator sample 1 after shrinkage through the thermal shrinkage rate evaluation device 100. A more specific shrinkage evaluation method is described below.

At least four reference points P1 to P4 constituting a square among a plurality of points representing the border of the sample may be set on the upper surface of the separator sample 1. In this case, for convenience of explanation, the present disclosure illustrates and describes an example in which the reference points P1 to P4 before and after thermal shrinkage of the separator sample 1 are formed at the same positions (vertices). Of course, the reference points Pl to P4 are not limited thereto, and may be displayed in the form of marks at predetermined positions formed on the upper surface of the separator sample 1 in various shapes, rather than at the vertices of a square.

The lighting unit 120 may emit light toward at least one of a top surface or a bottom surface of the separator sample 1.

For example, referring to FIG. 2, the lighting unit 120 may include a first lighting unit 121 that is provided below the mounting table 110 and emits light toward the bottom surface of the separator sample 1.

Preferably, the first lighting unit 121 may be integrally inserted inside the mounting table 110 and may emit light toward an entire area of the mounting table 110.

As another example, the lighting unit 120 may include a second lighting unit 122 that is provided above the mounting table 110 and emits light toward the top surface of the separator sample 1.

In this case, at least one second lighting unit 122 may be installed directly above the mounting table 110, or the second lighting unit 122 may be installed symmetrically on both sides of an upper part of the mounting table 110 to emit light obliquely toward the separator sample 1. In this case, the present disclosure does not limit the specific arrangement structure of the second lighting unit 122.

The imaging unit 140 takes an image of the separator sample 1. For example, the imaging unit 140 may be spaced apart from a portion directly above the separator sample 1 placed on the upper surface of the mounting table 110. Such an imaging unit 140 may take an image of the separator sample 1 irradiated with light through the first lighting unit 121 and the second lighting unit 122.

The evaluation unit 150 measures the thermal shrinkage rate of the separator sample 1 through the image taken by the imaging unit 140. Such an evaluation unit 150 may determine the degree of shrinkage by comparing measurement values L1 and L2 of the length in each direction of the separator sample 1 on the basis of the reference points Pl to P4 set on the upper surface of the separator sample 1 with a reference value R (see FIG. 3) before thermal shrinkage.

In this case, the evaluation unit 150 may ascertain the separator sample 1 by using the difference in brightness or gray scale of the taken image.

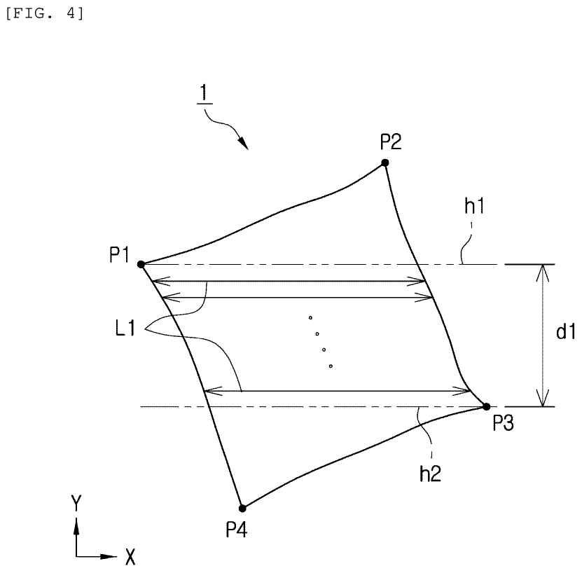

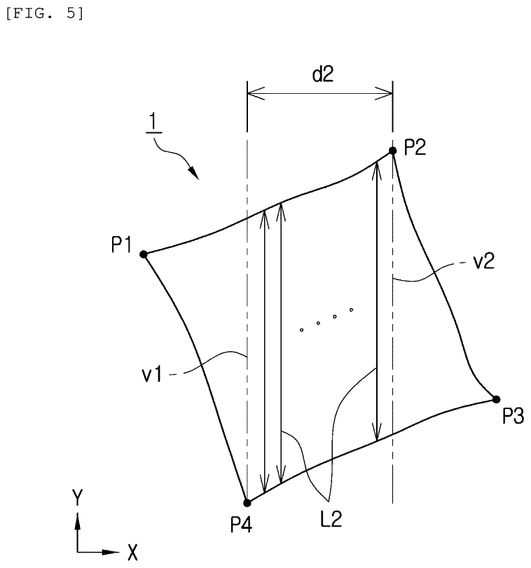

The evaluation unit 150 may set a first measurement range d1 (see FIG. 4) for measuring the length of the separator sample 1 in the X-axis direction and a second measurement range d2 (see FIG. 5) for measuring the length of the separator sample 1 in the Y-axis direction.

Specifically, referring to FIG. 4, the first measurement range dl may be set by selecting the two points P1 and P3 closest to the center of a plane of the separator sample 1 in the Y-axis direction among the four reference points set on the upper surface of the separator sample 1 and forming parallel virtual horizontal lines h1 and h2 passing through the selected two points P1 and P3, respectively. In the first measurement range dl between the virtual horizontal lines h1 and h2, a plurality of lengths L1 of the separator sample 1 in the X-axis direction may be measured. In this case, the evaluation unit 150 may select, as a measurement value L1, the shortest length among the plurality of lengths L1 measured in the first measurement range d1.

Referring to FIG. 5, the second measurement range d2 may be set by selecting the two points P2 and P4 closest to the center of the plane of the separator sample 1 in the X-axis direction among the four reference points P1 to P4 set on the upper surface of the separator sample 1 and forming parallel virtual vertical lines v1 and v2 passing through the selected two points P2 and P4, respectively. In the second measurement range d2 between the virtual vertical lines v1 and v2, a plurality of lengths L2 of the separator sample 1 in the Y-axis direction may be measured. In this case, the evaluation unit 150 may select, as a measurement value L2, the shortest length among the plurality of lengths L2 measured in the second measurement range d2, like the case of the first measurement range d1.

Hereinafter, a separator thermal shrinkage rate evaluation process using the above-described separator thermal shrinkage rate evaluation device 100 according to the present disclosure is described.

First, the separator sample 1 to be evaluated is cut to a reference value R of a predetermined size, and at least four reference points P1 to P4 are set on the upper surface of the cut separator sample 1 (see FIG. 3).

Subsequently, the cut separator sample 1 is shrunk by applying heat at a predetermined temperature and for a predetermined period of time.

Subsequently, the shrunken separator sample 1 is placed on the upper surface of the mounting table 110 and an image of the separator sample 1 is taken through the imaging unit 140 (see FIG. 2).

The evaluation unit 150 selects the two points P1 and P3 closest to the center of the plane of the separator sample 1 in the Y-axis direction among the four reference points P1 to P4 on the basis of the taken image. Subsequently, the evaluation unit 150 forms the parallel virtual horizontal lines h1 and h2 respectively passing through the two selected points P1 and P3, and measures the length L1 of the separator sample 1 in the X-axis direction in the first measurement range dl between the virtual horizontal lines h1 and h2 (see FIG. 4).

In addition, the evaluation unit 150 selects the two points P2 and P4 closest to the center of the plane of the separator sample 1 in the X-axis direction among the four reference points P1 to P4 on the basis of the taken image. Subsequently, the evaluation unit 150 forms the parallel virtual vertical lines v1 and v2 respectively passing through the two selected points P2 and P4, and measures the length L2 of the separator sample 1 in the Y-axis direction in the second measurement range d2 between the virtual vertical lines v1 and v2 (see FIG. 5).

In this case, the evaluation unit 150 may select the shortest lengths among the lengths measured in the first measurement range dl and the second measurement range d2 as the measurement values L1 and L2 in the X-axis direction and the Y-axis direction, respectively.

Finally, the evaluation unit 150 calculates a thermal shrinkage rate by comparing the measured length values L1 and L2 in the X-axis direction and the Y-axis direction with the reference value R (see FIG. 3).

The separator thermal shrinkage rate evaluation device 100 configured as described above according to the present disclosure sets the first and second measurement ranges dl and d2 in the X-axis direction and the Y-axis direction, respectively, on the basis of the four reference points P1 to P4 set on the separator sample 1 forming a square, and measures a thermal shrinkage rate by comparing the measured values L1 and L2 obtained by measuring the shortest lengths of the separator sample 1 in the measurement ranges with the reference value R, thereby obtaining more accurate data.

Although the present disclosure has been illustrated and described with reference to specific embodiments, the present disclosure is not limited to the above embodiments and various modifications and corrections can be made without departing from the technical spirit of the present disclosure.

1. A separator thermal shrinkage rate evaluation device comprising:
a mounting table configured to receive placement thereon of a separator sample to be evaluated;
a lighting unit configured to emit light toward at least one of a top surface or a bottom surface of the separator sample;
an imaging unit that is configured to record an image of the separator sample; and
an evaluation unit that is configured to determine a degree of shrinkage of the separator sample by comparing first and second lengths in respective first and second perpendicular directions of the separator sample measured using the image taken by the imaging unit with respective first and second reference lengths before thermal shrinkage.

2. The separator thermal shrinkage rate evaluation device according to claim 1, wherein the evaluation unit is configured to set at least four reference points constituting a square among a plurality of points representing a border of the separator sample.

3. The separator thermal shrinkage rate evaluation device according to claim 2, wherein the separator sample has a square shape, and each reference point is a vertex defined by an intersection of adjacent sides of the separator sample.

4. The separator thermal shrinkage rate evaluation device according to claim 2, wherein the evaluation unit is configured to determine:
a first measurement range set so that two Y-axis points closest to a center of a plane of the separator sample in a Y-axis direction are selected from the at least four reference points, parallel virtual horizontal lines respectively passing through the two Y-axis points are formed, and a plurality of lengths of the separator sample in an X-axis direction are measured in a range between the virtual horizontal lines; and
a second measurement range set so that two X-axis points closest to the center of the plane of the separator sample in the X-axis direction are selected from the at least four reference points, parallel virtual vertical lines respectively passing through the two X-axis points are formed, and a plurality of lengths of the separator sample in the Y-axis direction are measured in a range between the virtual vertical lines.

5. The separator thermal shrinkage rate evaluation device according to claim 4, wherein the evaluation unit is configured to select, as a measurement value, a shortest length among the plurality of lengths measured in the first measurement range and the second measurement range.

6. The separator thermal shrinkage rate evaluation device according to claim 1, wherein the evaluation unit is configured to ascertain the separator sample by using a difference in brightness or gray scale of the recorded image.

7. The separator thermal shrinkage rate evaluation device according to claim 1, wherein the lighting unit comprises:
a first lighting unit that is disposed below the mounting table and is configured to emit light toward a bottom surface of the separator sample; and
a second lighting unit that is disposed above the mounting table and is configured to emit light toward a top surface of the separator sample.

8. The separator thermal shrinkage rate evaluation device according to claim 7, wherein the first lighting unit is integrally disposed inside the mounting table and is configured to emit light toward an entire area of the mounting table.

9. The separator thermal shrinkage rate evaluation device according to claim 1, wherein the imaging unit is disposed above the mounting table.

10. A separator thermal shrinkage rate evaluation method comprising:
a first step of cutting a separator sample to be evaluated to a predetermined size and setting at least four reference points on an upper surface of the cut separator sample;
a second step of shrinking the separator sample by applying heat at a predetermined temperature for a predetermined period of time;
a third step of placing the separator sample on an upper surface of a mounting table and recording an image of the separator sample;
a fourth step of selecting two Y-axis points closest to a center of a plane of the separator sample in a Y-axis direction among the at least four reference points using the recorded image, forming parallel virtual horizontal lines respectively passing through the two Y-axis points, and measuring a length of the separator sample in an X-axis direction in a range between the virtual horizontal lines;
a fifth step of selecting two X-axis points closest to the center of the plane of the separator sample in the X-axis direction among the at least four reference points using the recorded image, forming parallel virtual vertical lines respectively passing through the two X-axis points, and measuring a length of the separator sample in the Y-axis direction in a range between the virtual vertical lines; and
a sixth step of calculating a thermal shrinkage degree by comparing the lengths measured in the X-axis direction and the Y-axis direction with reference lengths before thermal shrinkage of the separator sample.

11. The method according to claim 10, wherein, during the fourth step and the fifth step, shortest lengths among the lengths measured in the X-axis direction and the Y-axis direction are selected as X-axis and Y-axis measurement lengths.
